(19) United States
(12) Patent Application Publication
(10) Pub. No.: US 2007/0108188 A1
(43) Pub. Date: May 17, 2007

(54) Insulator for a PTC heater

(76) Inventors: Seock Hyo Lee, Chungnam (KR); Jeong Wook, Busan (KR)

Correspondence Address: MICHAEL BEST & FRIEDRICH, LLP, 100 E WISCONSIN AVENUE, Suite 3300, MILWAUKEE, WI, 53202, US

(21) Appl. No.: 11/594,456

(22) Filed: Nov. 8, 2006

(30) Foreign Application Priority Data
Nov. 15, 2005 (KR) 10-2005-109229

(51) Int. Cl. H05B 1/02

(52) U.S. Cl. 219/504

(57) ABSTRACT

The present invention provides an insulator for a PTC heater enclosing an anode terminal. The insulator comprises a first piece having an opening formed therein for exposing a portion of a surface of the anode terminal, and a second piece having an opening formed therein for exposing a portion of another surface of the anode terminal. The second piece is removably coupled to the first piece. A plurality of first guide protrusions are located along a surface of the first piece and the second piece defines first guide grooves corresponding to the first guide protrusions so that the protrusions face the recesses along a longitudinal direction of the respective pieces. The insulator also includes passing grooves formed at positions of the anode terminal corresponding to the first guide protrusions and the first guide grooves.

### CROSS-REFERENCE TO RELATED APPLICATION

The present application claims priority, under 35 U.S.C. § 119, to South Korean patent Application No. 10-2005-109229 filed Nov. 15, 2005, the contents of which are hereby incorporated by reference in their entirety.

### FIELD OF INVENTION

The present invention relates to an insulator provided in a PTC rod assembly, and more particularly, to an insulator for a PTC heater comprising a pair of pieces to be removably coupled to an anode terminal.

### BACKGROUND

Generally, vehicles include a heating apparatus for heating the interior of the vehicle. Such heating apparatuses can also use thermal energy from cooling water heated by the vehicle engine to remove moisture or frost from a windshield of the vehicle.

The cooling water of the heating apparatus flows through the engine after the engine is started and is heated over an extended period of time. Accordingly, there is a problem in that the driver and passengers are required to sit in the cold interior of the vehicle for a certain period of time after the engine is started.

To solve this and other problems, an apparatus for receiving a ceramic heating element, such as, for example, a PTC (Positive Temperature Coefficient) element has been suggested.

FIG. 1a is a perspective view of a conventional PTC rod assembly, and FIG. 1b is an exploded perspective view of the PTC rod assembly shown in FIG. 1a.

As shown in FIGS. 1a, 1b, a conventional PTC rod assembly 1 comprises a first PTC rod 10 formed in an elongate channel shape with an open portion, a second PTC rod 20 coupled to the first PTC rod 10 to cover the open portion of the first PTC rod 10, an anode terminal 40 positioned in the first PTC rod 10 and enclosed by an insulator 30 not to be in contact with the first PTC rod 10, PTC elements 50 placed between one surface of the anode terminal 40 and the second PTC rod 20, and heat transfer blocks 60 made of a material with high thermal conductivity and brought into contact with the other side surface of the anode terminal 40.

Each of the PTC elements 50 is coupled such that one surface thereof is in contact with the anode terminal 40 and the other surface thereof is in contact with the second PTC rod 20 acting as a cathode terminal. The PTC elements generate heat when electric power is applied thereto. At this time, because the first PTC rod 10 and the second PTC rod 20 are coupled to be brought into contact with each other, not only the second PTC rod 20 but also the first PTC rod 10 acts as a cathode terminal.

Further, when the first and second PTC rods 10 and 20 are coupled to each other, enlarged portions 32 and 34 brought into close contact with inner surfaces of the first and second PTC rods 10 and 20 are formed at both ends of the insulator 30. Accordingly, an inner space defined by the first and second PTC rods 10 and 20 is sealed by the enlarged portions 32 and 34.

Such a conventional insulator 30 is manufactured by injection molding an insulation material around an insert (i.e., the anode terminal 40) to increase the strength of the insulator 30 and the adhesion thereof with the insert. That is, the insulator 30 is manufactured by an insert injection molding process, by preparing a mold, positioning the anode terminal 40 in the mold, and injection molding the insulator 30 around the anode terminal 40. Thus, because the conventional insulator 30 is manufactured using a plurality of steps, there are disadvantages in that the manufacture is complicated and workability is deteriorated. In addition, due to the complicated nature of the manufacturing process, there are also problems in that the production rate is lowered and thus mass production is particularly complicated.

### SUMMARY

Accordingly, the present invention is conceived to solve the aforementioned and other problems in the prior art. An independent object of the present invention is to provide an insulator for a PTC heater, which is simple to manufacture and assemble, allows an increase in workability and production rate, and makes mass production possible, by removably coupling a pair of pieces separately manufactured to an anode terminal.

One embodiment of the present invention provides an insulator for a PTC heater enclosing an anode terminal. The insulator comprises a first piece having an opening formed therein for exposing a portion of a surface of an anode terminal, and a second piece having an opening formed therein for exposing a portion of the other surface of the anode terminal. The second piece is removably coupled to the first piece.

In some embodiments, a plurality of first guide protrusions and first guide grooves corresponding to the first guide protrusions are formed on respective surfaces of the first and second pieces facing each other along a longitudinal direction of the respective pieces. Grooves through which the first guide protrusions pass are formed at positions of the anode terminal corresponding to the first guide protrusions and the first guide grooves.

### BRIEF DESCRIPTION OF THE DRAWINGS

The above and other objects, features and advantages of the present invention will become apparent from the following description of a preferred embodiment given in conjunction with the accompanying drawings, in which:

FIG. 1a is a perspective view of a conventional PTC rod assembly;

FIG. 1b is an exploded perspective view of the PTC rod assembly shown in FIG. 1a;

FIG. 2a is a perspective view of an insulator for a PTC heater according to a first embodiment of the present invention;

FIG. 2b is an exploded perspective view of the insulator shown in FIG. 2a;

FIG. 3a is a perspective view of an insulator for a PTC heater according to showing a second embodiment of the present invention;

FIG. 3b is an exploded perspective view of the insulator shown in FIG. 3a;

FIG. 4a is a perspective view of an insulator for a PTC heater according to a third embodiment the present invention; and

FIG. 4b is an exploded perspective view of the insulator shown in FIG. 4a.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

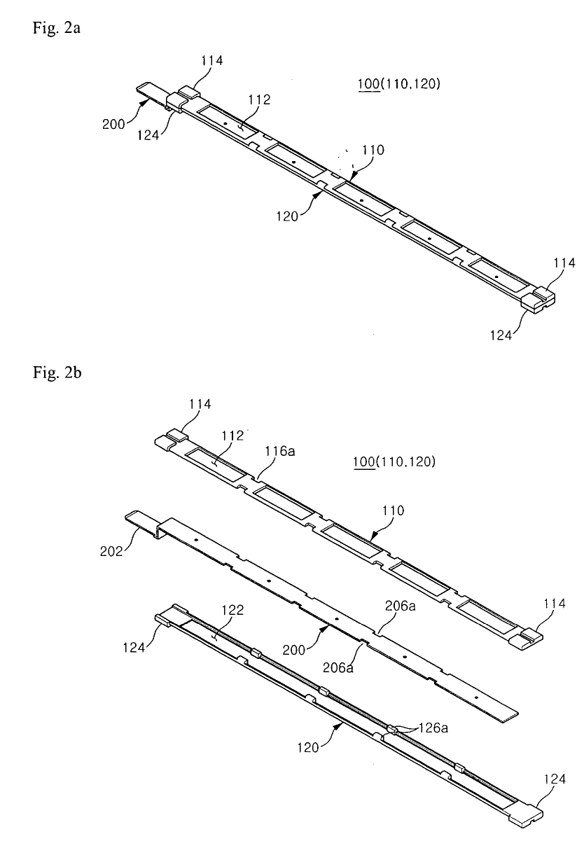

FIG. 2a is a perspective view showing a first embodiment of an insulator for a PTC heater according to the present invention, and FIG. 2b is an exploded perspective view of the first embodiment shown in FIG. 2a.

As shown in FIGS. 2a and 2b, the first embodiment of the insulator 100 for a PTC heater according to the present invention comprises a pair of pieces 110 and 120, which are formed to extend in the longitudinal direction of an anode terminal 200 and are coupled to the anode terminal 200 to enclose the anode terminal 200. The pair of pieces comprises a first piece 110 coupled to a top surface of the anode terminal 200, a second piece 120 coupled to a bottom surface of the anode terminal 200 and removably coupled to the first piece 110.

The first and second pieces 110 and 120 are respectively formed with openings 112 and 122 so that the top and bottom surfaces of the anode terminal 200 are partially exposed. Enlarged portions 114 and 124 are provided at both ends of the first and second pieces 110 and 120 to have a cross section larger than the remainder of first and second pieces 110 and 120, respectively. In more detail, the openings 112 and 122 are portions through which PTC elements and heat transfer blocks (not shown) are seated and coupled. In addition, the enlarged portions 114 and 124 are provided to seat a PTC rod (not shown) between the enlarged portions 114 and 124 and to guide their coupling position.

In the illustrated embodiment of FIGS. 2a and 2b, five openings 112 are formed in the first piece 110, each of which is formed to have a predetermined length in the longitudinal direction of the first piece 110. As shown in FIGS. 2a and 2b, the openings 112 can be apart from each other at regular intervals. That is, in the illustrated embodiment, because the five openings 112 are formed in the first piece 110, the number of the PTC elements or heat transfer blocks is limited to five.

On the other hand, the opening 122 formed in the second piece 120 extends in the longitudinal direction of the second piece 120, and four pairs of first guide protrusions 126a are formed in the opening 122 to be spaced apart from each other at regular intervals in the longitudinal direction of the second piece 120. Each pair of the first guide protrusions 126a face each other on opposite inside ends of the second piece 120. That is, in the illustrated embodiment of FIGS. 2a and 2b, the opening 122 formed in the second piece 120 is divided into five regions by the four pairs of the first guide protrusions 126a, so that the five PTC elements or heat transfer blocks are coupled thereto.

The first guide protrusions 126a divide the opening 122 formed in the second piece 120 into a plurality of the regions and allow the PTC elements or heat transfer blocks to be coupled to the second piece 120, and at the same time, the first guide protrusions 126a are used to couple the first piece 110 and the second piece 120. In addition, because each pair of the first guide protrusions 126a is formed to be spaced apart from adjacent pairs of guide protrusions 126b by a distance shorter than the width of the opening 122, it is possible to allow the PTC elements or heat transfer blocks to be seated in the opening 122 without an additional support dividing the opening.

In more detail, the first guide protrusions 126a are formed to protrude toward the inside of the opening 122 formed in the second piece 120 and at the same time to protrude toward the top surface of the second piece 120 by a predetermined height. In addition, first guide grooves 116a are formed at positions of the first piece 110 corresponding to the first guide protrusions 126a of the second piece 120 such that the first guide protrusions 126a can be respectively inserted into the first guide grooves 116a. Therefore, when coupling the first and second pieces 110 and 120 to each other, upper ends of the first guide protrusions 126a are respectively inserted into and coupled to the first guide grooves 116a. At this time, the first guide grooves 116a and the first guide protrusions 126a are positioned in both side ends of the first and second pieces 110 and 120, and more particularly, between adjacent openings 112.

The anode terminal 200 is positioned between the first piece 110 and the second piece 120, extends in the same direction as the longitudinal direction of the pieces 110 and 120, and has a terminal portion 202 formed at an end. As shown in FIGS. 2a and 2b, the terminal portion can be bent at a predetermined angle. Further, passing grooves 206a are formed along both sides of the anode terminal 200 at positions corresponding to the first guide grooves 116a and the first guide protrusions 126a so that the first guide protrusions 126a can pass through the passing grooves 206a. In this manner, the passing grooves 206a prevent the anode terminal 200 from moving through an inner space defined by the pair of pieces 110 and 120 when coupled to the pieces 110 and 120.

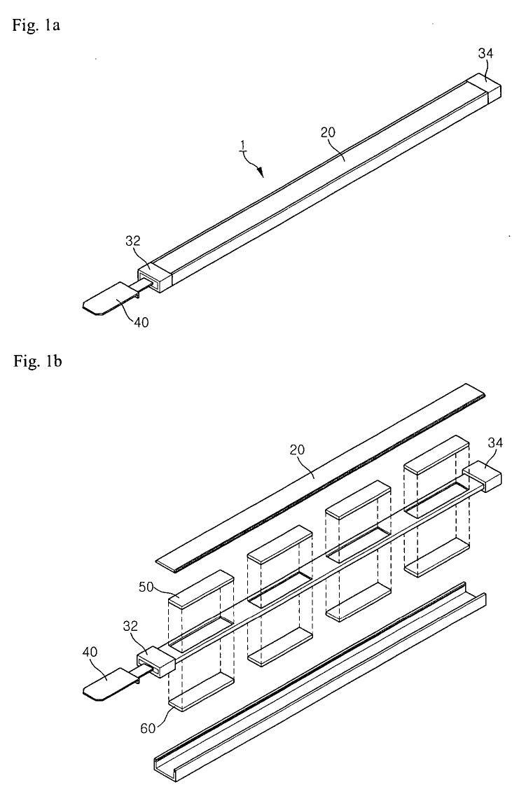

Although the illustrated embodiment of FIGS. 1a and 1b includes five openings 112, 122 to which the PTC elements or heat transfer blocks are coupled, in other embodiments each of the first piece 110 and the 120 can have any other number of openings 112. That is, more or less of the openings or the divided regions of the opening may be formed. Further, in the present embodiment, the first guide grooves 116a and the first guide protrusions 126a are respectively formed in the first piece 110 and the second piece 120, but the present invention is not limited to such a construction. Furthermore, although in the present embodiment, the single opening 122 is formed in the second piece 120 and the first guide protrusions 126a are formed in the opening 122, the opening 122 may be divided into a plurality of regions by forming supports between the pairs of the first guide protrusions 126a.

A process of assembling the first embodiment of the insulator 100 according to the present invention so configured will be described below.

First, the anode terminal 200 having the terminal portion 202 formed at an end thereof is provided. After preparing the first and second pieces 110 and 120 respectively above and below the anode terminal 200, the first and second pieces 110 and 120 are coupled such that the anode terminal 200 is positioned in an the inner space defined by the pair of pieces 110 and 120. At this time, the first guide protrusions 126a of the second piece 120 pass through the passing grooves 206a of the anode terminal 200 and then are inserted into and coupled to the first guide grooves 116a of the first piece 110.

The insulator 100 is assembled as described above such that the pair of pieces 110 and 120 are separately manufactured and are coupled to each other to enclose the anode terminal 200. Thus, it is easy to manufacture the insulator 100 and simple to assemble it, thereby enhancing the workability and increasing the production rate.

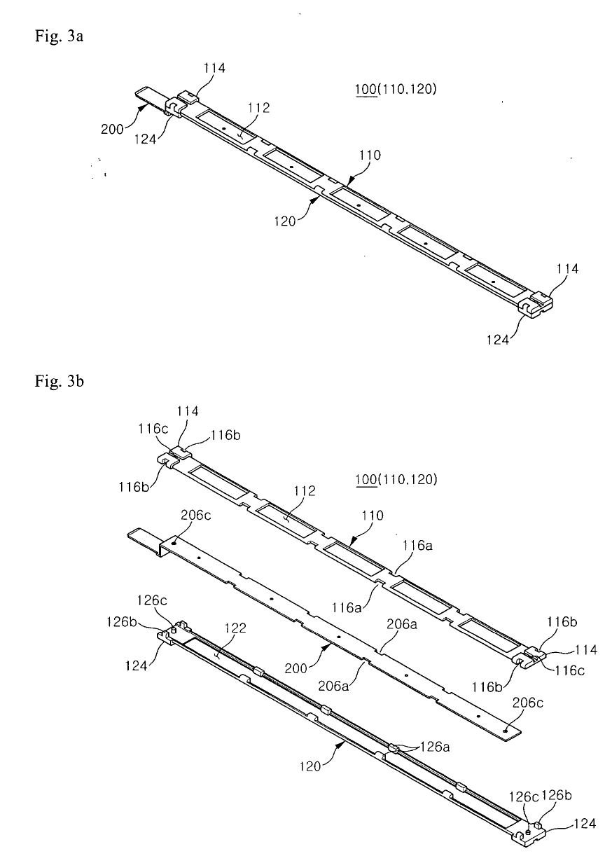

FIG. 3a is a perspective view showing a second embodiment of the insulator for a PTC heater according to the present invention, and FIG. 3b is an exploded perspective view of the second embodiment shown in FIG. 3a.

As shown in FIGS. 3a and 3b, the second embodiment of the insulator 100 for a PTC heater according to the present invention comprises a pair of pieces 110 and 120, which are coupled to an anode terminal 200 to enclose it, as in the first embodiment. The pair of pieces comprises a first piece 110 coupled to a top surface of the anode terminal 200, a second piece 120 coupled to a bottom surface of the anode terminal 200 and removably coupled to the first piece 110.

Here, because the second embodiment is similar to the first embodiment except for the enlarged portions 114 and 124 formed at both the ends of the first and second pieces 110 and 120, the detailed descriptions of the similar portions will be omitted.

The first and second pieces 110 and 120 are formed with openings 112 and 122 so that the top and bottom surfaces of the anode terminal 200 are partially exposed. Enlarged portions 114 and 124 are provided in both ends of the first and second pieces 110 and 120. These enlarged portions 114 and 124 have a cross section larger than the remainder of the first and second pieces 110 and 120, respectively. 100401 A plurality of first guide protrusions 126a are formed along the second piece 120 and extend into the opening 122 of the second piece 120. These first guide protrusions 126a are spaced apart from each other at regular intervals in the longitudinal direction of the second piece 120. In addition, first guide grooves 116a are formed at positions of both side ends of the first piece 110 corresponding to the first guide protrusions 126a so that upper ends of the first guide protrusions 126a can be respectively inserted into the first guide grooves 11 6a. Also, passing grooves 206a through which the first guide protrusions 126a pass are formed at positions of the anode terminal 200 corresponding to the first guide grooves 116a and the first guide protrusions 126a.

The enlarged portions 114 and 124 are provided at both the ends of the first and second pieces 110 and 120, as described above, and second guide protrusions 126b and second guide grooves 116b corresponding to the second guide protrusions 126b are formed on both opposite surfaces of the enlarged portions 114 and 124. That is, the second guide protrusions 126b having the same shape as the first guide protrusions 126a are formed in both side ends of a top surface of each enlarged portion 124 of the second piece 120, and the second guide grooves 11 6b corresponding to the second guide protrusions 126b and having the same shape as the first guide protrusions 126a are formed in both side ends of a bottom surface of each enlarged portion 114 of the first piece 110. Therefore, the second guide protrusions 126b are inserted into and coupled to the second guide grooves 116b when the first and second pieces 110 and 120 are coupled together.

The second guide grooves 116b and the second guide protrusions 126b are formed outside both side ends of the anode terminal 200, so that no passing groove is formed in the side ends of the anode terminal 200.

A guide protrusion 126c is formed to protrude upward on a central portion of the top surface of each enlarged portion 124 of the second piece 120, and a third guide groove 116c corresponding to the third guide protrusion 126c is further formed on a central portion of the bottom surface of each enlarged portion 114 of the first piece 110. In addition, through-holes 206c are formed at positions of the anode terminal 200 corresponding to the third guide grooves 116c and the third guide protrusions 126c so that the third guide protrusions 126c pass through the through-holes 206c. Thus, when the first and second pieces 110 and 120 are coupled to each other, the third guide protrusions 126c pass through the through-holes 206c and are then inserted into and coupled to the third guide grooves 116c.

In addition, the third guide grooves 116c are formed along the first piece 110, and the third guide protrusions 126c pass through the third guide grooves 116c and are coupled thereto. Thus, it is possible to securely couple the first and second pieces 110 and 120.

Further, although in the present embodiment, the single opening 122 is formed in the second piece 120 and the first guide protrusions 126a are formed in the opening 122, the opening 122 may be divided into a plurality of regions by forming supports between the respective pairs of the first guide protrusions 126a.

In the second embodiment of the insulator 100 for a PTC heater, the second and third guide grooves 116b and 116c and the second and third guide protrusions 126b and 126c are further formed in addition to the first guide grooves 116a and the first guide protrusions 126a. Thus, there is an advantage in that it is possible to increase the adhesion of the insulator 100 to the anode terminal 200.

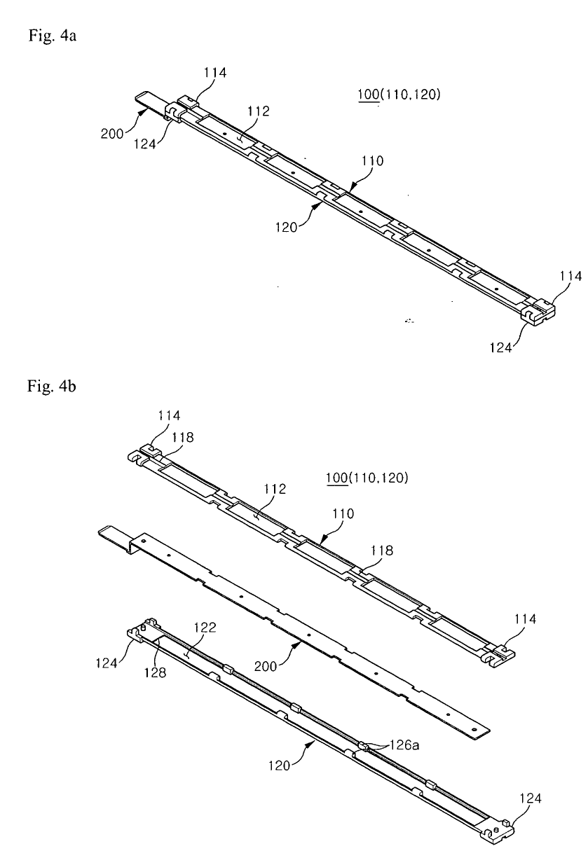

FIG. 4a is a perspective view showing a third embodiment of the insulator for a PTC heater according to the present invention, and FIG. 4b is an exploded perspective view of the third embodiment shown in FIG. 4a.

As shown in FIGS. 4a and 4b, the third embodiment of the insulator 100 for a PTC heater according to the present invention comprises a pair of pieces 110 and 120, which are coupled to an anode terminal 200 to enclose it, as in the first embodiment. The pair of pieces comprises a first piece 110 coupled to a top surface of the anode terminal 200, a second piece 120 coupled to a bottom surface of the anode terminal 200 and removably coupled to the first piece 110.

The first and second pieces 110 and 120 are formed with openings 112 and 122 so that the top and bottom surfaces of the anode terminal 200 are partially exposed to the outside. Enlarged portions 114 and 124 are provided in both ends of the first and second pieces 110 and 120 to have a cross section larger than the first and second pieces 110 and 120, respectively.

Hereinafter, because the third embodiment is similar to the second embodiment, the descriptions of the similar portions will be omitted.

Five openings 112 are formed in the first piece 110, and each of the openings 112 is formed to have a predetermined length in the longitudinal direction of the first piece 110. The openings 112 are arranged to be spaced apart from each other at regular intervals. In addition, the opening 122 formed in the second piece 120 extends in the longitudinal direction of the second piece 120. Four pairs of first guide protrusions 126a are formed along the opening 122 and spaced apart from each other at regular intervals in the longitudinal direction of the second piece 120.

Gas discharge ports 118 are formed in the first piece 110 between the openings 112 to discharge gas generated when the PTC elements coupled to openings 112 generate heat. In addition, gas discharge ports 118 are also formed in the enlarged portions 114 of the first piece 110 so that the gas can be discharged to the outside.

Here, because the second piece 120 is formed with a single opening 122, an additional gas discharge port is not necessary. However, gas discharge ports 128 are formed in the enlarged portions 124 in order to discharge the remaining gas in the opening 122 to the outside.

When supports are formed between the respective pairs of the first guide protrusions 126a, it is preferred that the gas discharge ports be formed in the supports.

In addition to the embodiments of the present invention, by separately manufacturing any one of the first and second pieces after injection molding the other of the first and second pieces on the anode terminal, it is possible to couple them.

The insulator for a PTC heater according to the present invention comprises a pair of pieces separately manufactured and the pair of pieces are removably coupled to the anode terminal, whereby the manufacture and assembly thereof is simplified.

Also, due to the simplified manufacture and assembly, there are advantages in that the workability and production rate can be improved and mass production is made possible.

Although the insulator for a PTC heater according to the preferred embodiments of the present invention is described based on the aforementioned descriptions and accompanying drawings, this is merely for illustrative purposes. It will be apparent that those skilled in the art can make various modifications and changes thereto without departing from the spirit of the present invention. Various features and advantages of the invention are set forth in the following claims.

What is claimed is:

1. An insulator for a PTC heater enclosing an anode terminal, the heater comprising:
a first piece having an opening formed therein to expose a portion of a surface of the anode terminal; and
a second piece having an opening formed therein to expose a portion of an other surface of the anode terminal, the second piece being removably coupled to the first piece.

2. The insulator of claim 1, wherein a plurality of guide protrusions are positioned along a surface of one of the first piece and the second piece and a plurality of first guide grooves corresponding to the first guide protrusions are defined along a surface of an other of the first piece and the second piece, the protrusions facing the grooves along a longitudinal direction of the first and second pieces, and wherein recesses are formed along the anode terminal at positions corresponding to the first guide protrusions and the first guide grooves.

3. The insulator of claim 2, wherein an enlarged portion is formed at least an end of each of the first and second pieces, and wherein a second guide protrusion and a second guide groove are formed in surfaces of the enlarged portions facing each other, respectively.

4. The insulator of claim 2, wherein the first guide protrusions and the first guide grooves are formed in both side ends of the first and second pieces to face each other, and wherein a pair of the first guide protrusions facing each other are formed to be spaced apart from each other by a distance shorter than a width of the opening in the second piece.

5. The insulator of claim 2, wherein a third guide protrusion is positioned on and a third guide groove corresponding to the third guide protrusion is defined in a central portion of an end of one of the first piece and the second piece, and wherein a through-hole through which the third guide protrusion passes is formed at a position of the anode terminal corresponding to the third guide protrusion and third guide groove.

6. The insulator of claim 5, wherein the end of the one of the first piece and the second piece defines a gas discharge port.

7. The insulator of claim 1, wherein the opening in the first piece is a first opening, and wherein the first piece defines a second opening and a gas discharge port between the first opening and the second opening.
